(19) United States
(12) Patent Application Publication
(10) Pub. No.: US 2026/0116348 A1
(43) Pub. Date: Apr. 30, 2026

(54) CYLINDER ROLLER WHEEL DEVICE

(71) Applicants: Romeo Garza, McAllen, TX (US); Benjamin Hinojosa, McAllen, TX (US)

(72) Inventors: Romeo Garza, McAllen, TX (US); Benjamin Hinojosa, McAllen, TX (US)

(21) Appl. No.: 19/429,461

(22) Filed: Dec. 22, 2025

Related U.S. Application Data
(63) Continuation-in-part of application No. 19/218,803, filed on May 27, 2025.
(60) Provisional application No. 63/713,104, filed on Oct. 29, 2024.
(60) Provisional application No. 63/737,965, filed on Dec. 23, 2024.

(51) Int. Cl. B60S 1/68; B60B 19/12

(52) U.S. Cl. CPC B60S 1/68; B60B 19/12

(57) ABSTRACT

A cylinder roller wheel device is provided. The device is comprised of a cylindrical wheel body that comprises an outer layer formed from high-friction, wear-resistant materials featuring one or more surface textures to enhance traction. The frame assembly comprises a horizontal frame member and a pair of frame arms extending downward to support a central axle that passes through the wheel body. A secondary horizontal frame member may be laterally offset from the primary frame and serves as a mounting base for the cleaning mechanism. The cleaning mechanism comprises a bristle or scraping interface arranged to maintain contact with the wheel surface, thereby removing debris such as mud, soil, sand, and gravel during rotation.

### CROSS-REFERENCE TO RELATED APPLICATION

The present application is a continuation-in-part patent application of, and claims priority to and the benefit of, U.S. patent application Ser. No. 19/218,803, which was filed on May 27, 2025, which claims priority to and the benefit of U.S. Provisional Application No. 63/713,104, which was filed on Oct. 29, 2024, and claims priority to and the benefit of U.S. Provisional Application No. 63/737,965, which was filed on Dec. 23, 2024, all of which are incorporated herein by reference in their entirety.

### FIELD OF THE INVENTION

The present invention relates generally to the field of wheels. More specifically, the present invention relates to a cylinder roller wheel device with an integrated cleaning mechanism that maintains contact with the wheel surface to actively remove debris such as mud, soil, sand, and gravel from the wheel during use. Accordingly, the present disclosure makes specific reference thereto. Nonetheless, it is to be appreciated that aspects of the present invention are also equally applicable to other like applications, devices, and methods of manufacture.

### BACKGROUND

Transporting loads across uneven or obstructed terrain using carts, wagons, wheelbarrows, or any load-bearing wheel-based devices presents recurring operational challenges. For specifically, conventional wheels frequently experience impediments such as becoming stuck in soft ground or losing balance over irregular surfaces, including mud, gravel, sand, and dirt. These issues often result in increased physical exertion for the user, diminished maneuverability, and heightened risk of tipping or spilling the load being transported. In commercial, agricultural, and construction settings, such limitations can lead to delays, inefficiencies, and potential material loss. Furthermore, standard wheel configurations do not account for active mitigation of debris accumulation, which further compounds the problem by adding friction, reducing traction, and altering the effective geometry of the wheel during use. Repeated maintenance and manual cleaning of wheels to restore function also introduces additional downtime and labor costs. Moreover, users frequently encounter challenges in maintaining load stability when the transport platform traverses sloped or loose terrain. These persistent problems demonstrate the lack of an integrated solution that enhances wheel performance and reliability over unpredictable terrain conditions.

Therefore, there exists a long-felt need in the art for a cylinder roller wheel device that enables stable and continuous movement of wheeled, transport devices over mud, gravel, sand, and similarly uneven surfaces. There also exists a long-felt need in the art for a cylinder roller wheel device that prevents debris accumulation on the wheel surface during operation. Moreover, there exists a long-felt need in the art for a cylinder roller wheel device that improves load-bearing performance and minimizes user fatigue associated with moving carts or wheelbarrows across rough terrain.

The subject matter disclosed and claimed herein, in one embodiment thereof, comprises a cylinder roller wheel device. The device is comprised of a cylindrical wheel body configured to rotate about a central longitudinal axis, a frame assembly for structural support and mounting, and an integrated cleaning mechanism for real-time debris removal. More specifically, the wheel body comprises an outer layer formed from high-friction, wear-resistant materials featuring one or more surface textures to enhance traction. In certain embodiments, the wheel body may be solid, semi-hollow, or hollow, and may incorporate internal reinforcement structures for enhanced structural performance. In one embodiment, the frame assembly comprises a horizontal frame member and a pair of frame arms extending downward to support a central axle that passes through the wheel body. In this embodiment, a secondary horizontal frame member may be laterally offset from the primary frame and serves as a mounting base for the cleaning mechanism. The cleaning mechanism comprises a bristle or scraping interface arranged to maintain contact with the wheel surface, thereby removing debris such as mud, soil, sand, and gravel during rotation. In one embodiment, the cleaning interface may be held in consistent engagement with the wheel surface via a spring mechanism that applies a regulated downward force, accommodating surface irregularities and material wear.

In this manner, the cylinder roller wheel device of the present invention accomplishes all the foregoing objectives and provides a wheel that improves motion stability across irregular surfaces with an optional self-cleaning feature. The textured, outer layer further maximizes ground engagement. The debris-removal mechanism further maintains optimal wheel performance by preventing material buildup during operation, thereby reducing user fatigue and minimizing the risk of load spillage. By addressing the limitations of traditional wheel systems, the cylinder roller wheel device enhances functionality and reliability for various transport applications operating in rugged environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cylinder roller wheel device. The device is a wheel designed to enhance terrain mobility, stability, and operational flexibility for all wheel-based transport vehicles including but not limited to wagons, carts, wheelbarrows, or any load-bearing wheel-based device. More specifically, the device is comprised of a wide-profile wheel body, that may vary in length or width, featuring enhanced grip and a self-cleaning mechanism. This configuration minimizes terrain entrapment, improves movement over varied substrates, and reduces maintenance by removing obstructive material during operation.

The device is comprised of a cylindrical wheel body rotating about a central longitudinal axis. The exterior surface of the wheel body may include an outer layer composed of high-friction, wear-resistant material to enhance traction and durability. The surface may include at least one texture feature to optimize contact with ground surfaces.

A horizontal frame member is positioned above the wheel body, with at least one frame arm extending downward from the lateral end. In one embodiment, a pair of frame arms may be parallel or diverging and may be fixed or pivotally attached to allow angular adjustment of the wheel axis. Each frame arm connects to a central axle that allows the wheel body to rotate freely.

In one embodiment, the horizontal frame member may include at least one extension frame member extending laterally, supporting a secondary horizontal frame member. The secondary frame member, which may be aligned parallel or at an angle to the wheel axis, provides a mounting point for a cleaning mechanism. A cleaning interface is mounted to the secondary frame member and maintains surface contact with the outer layer of the wheel body. The cleaning interface may include bristles, or alternatively or additional include scraping components such as rubber fins or rigid blades for mechanical debris removal.

During wheel movement, the cleaning interface actively removes accumulated debris such as mud, soil, gravel, sand, or vegetation from the outer surface. In one embodiment, a spring mechanism may connect the cleaning interface to the secondary frame member, applying a constant downward force to ensure continuous and effective surface contact regardless of wear or surface variation.

Accordingly, the cylinder roller wheel device of the present invention is particularly advantageous as it provides a wheel that improves motion stability across irregular surfaces. The textured, outer layer further maximizes ground engagement. An embodiment with a debris-removal mechanism further maintains optimal wheel performance by preventing material buildup during operation, thereby reducing user fatigue and minimizing the risk of load spillage. By overcoming the limitations of traditional wheel systems, the cylinder roller wheel device enhances functionality and reliability for various transport applications operating in rugged environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cylinder roller wheel device of the present invention in accordance with the disclosed architecture; and

FIG. 2 illustrates a perspective view of one potential embodiment of a cylinder roller wheel device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cylinder roller wheel device that enables stable and continuous movement of wheeled, transport devices over mud, gravel, and similarly uneven surfaces. There also exists a long-felt need in the art for a cylinder roller wheel device that prevents debris accumulation on the wheel surface during operation. Moreover, there exists a long-felt need in the art for a cylinder roller wheel device that improves load-bearing performance and minimizes user fatigue associated with moving carts, wheelbarrows, or any load-bearing wheel-based devices across rough terrain.

The present invention, in one exemplary embodiment, is comprised of a cylinder roller wheel device. The wheel device is designed to improve terrain mobility, operational stability, and functional versatility for transport vehicles such as wagons, carts, wheelbarrows, and any other load-bearing wheel-based device. The device is comprised of a wide-profile wheel body that incorporates enhanced grip features and a self-cleaning mechanism. Through this configuration, terrain entrapment is reduced, movement across uneven surfaces is improved, and maintenance requirements are minimized by actively removing obstructive material during use.

The wheel body is cylindrical and rotates about a central longitudinal axis. The exterior surface includes an outer layer made from high-friction, wear-resistant material to improve traction and durability. At least one textured feature may be present on the surface to optimize ground contact.

Positioned above the wheel body is a horizontal frame member, from which at least one frame arm extends downward from the lateral end. In certain embodiments, a pair of frame arms may be employed, either in a parallel or diverging configuration, and may be fixed or pivotally attached to allow angular adjustment of the wheel axis. Each frame arm connects to a central axle, enabling free rotation of the wheel body.

The horizontal frame member may also support at least one extension frame member extending laterally. This extension supports a secondary horizontal frame member, which may be positioned either parallel to or at an angle relative to the axis of the wheel. The secondary frame member serves as a mounting point for a cleaning mechanism. A cleaning interface is mounted to this secondary frame member and maintains direct contact with the outer layer of the wheel body. The cleaning interface may include bristles or, in addition or alternatively, scraping elements such as rubber fins or rigid blades to mechanically dislodge debris.

As the wheel body rotates during motion, the cleaning interface actively removes debris such as mud, soil, gravel, sand, or vegetation from the outer surface. In one embodiment, a spring mechanism is used to connect the cleaning interface to the secondary frame member, applying a constant downward force to ensure effective contact with the wheel surface despite wear or surface irregularities.

As a result, the device integrates debris-removal capabilities directly into a wheel structure, enhancing motion stability over rough or obstructed terrain. The textured outer layer further maximizes surface engagement, while the cleaning mechanism sustains optimal wheel performance by preventing material accumulation. This reduces user fatigue and minimizes the risk of load spillage, thereby improving the reliability and utility of transport systems operating in challenging environments.

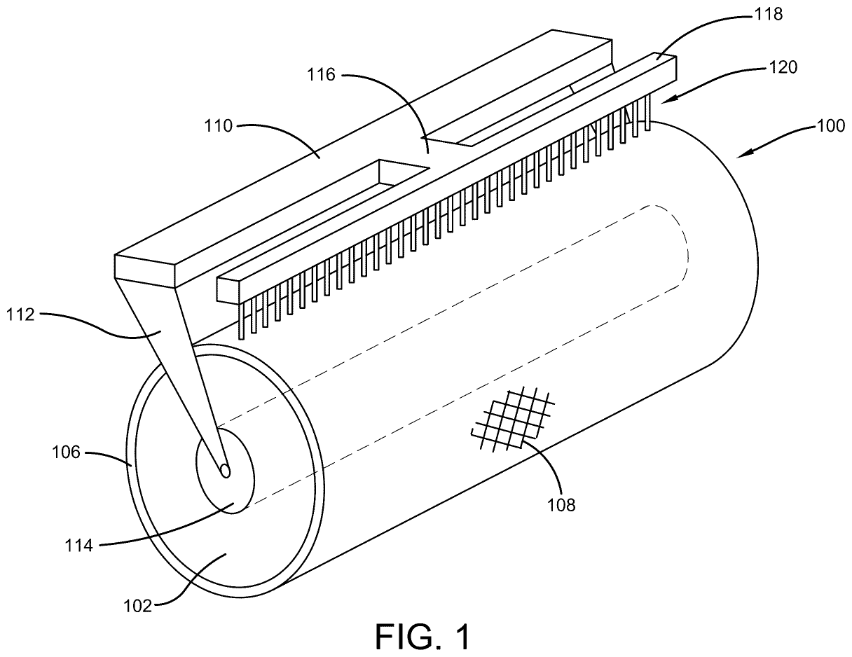

Referring initially to the drawings, FIG. 1 illustrates a perspective view of one potential embodiment of a cylinder roller wheel device 100 of the present invention in accordance with the disclosed architecture. The device 100 is designed to improve the terrain performance, stability, and operational versatility of existing wheel-based, load-bearing transport vehicles such as but not limited to wagons, hand carts, wheelbarrows, and similar wheel-based platforms and devices. More specifically, the device 100 enables continued motion over surfaces that may be soft, uneven, or obstructed with debris by incorporating a wide-profile wheel body 102 with enhanced grip characteristics and an integrated self-cleaning mechanism. This configuration reduces the risk of terrain entrapment while facilitating smoother movements across variable substrates and reducing maintenance requirements by actively removing obstructive material from the wheel body 102 during operation. In different embodiments, the device 100 may be configured for unidirectional or multidirectional motion and may be adapted for installation on single-wheel, dual-wheel, or multi-axle systems depending on the embodiment.

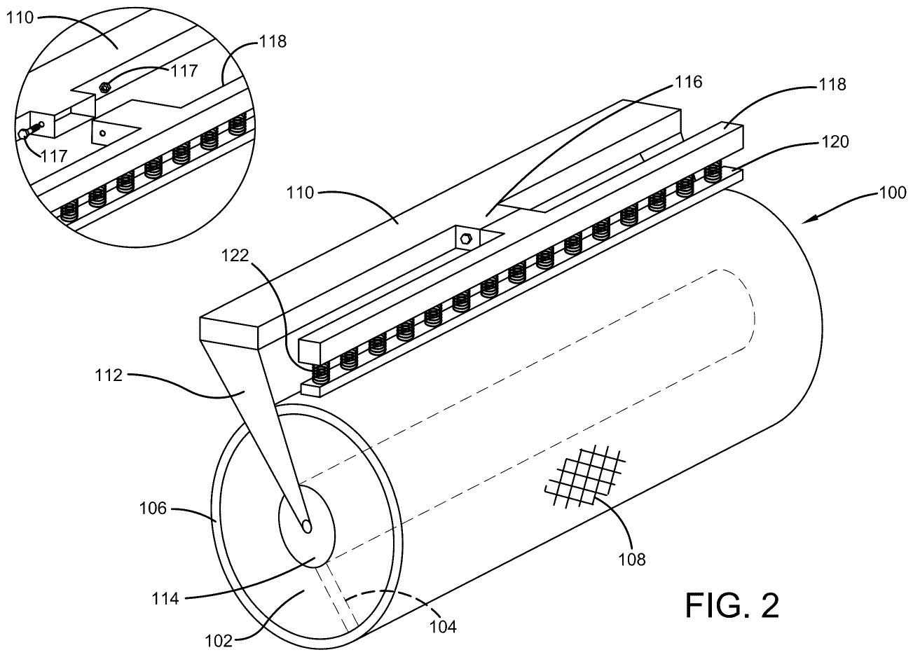

The device 100 may be comprised of at least one cylindrical wheel body 102 that rotates about a central longitudinal axis. The wheel body 102 may exhibit a symmetrical or asymmetrical cross-sectional profile and may be manufactured in solid, semi-hollow, or fully hollow configurations. The wheel body 102 may differ in diameter in various embodiments. In embodiments where the wheel body 102 is hollow, internal reinforcement structures 104 (as seen in FIG. 2) such as but not limited to any combination of radial ribs, structural spokes, or honeycomb-patterned lattices that may be incorporated to enhance torsional rigidity and impact resistance without substantially increasing weight. The wheel body 102 may be made from any suitable material such as but not limited to thermoplastics, wood composites, ferrous or non-ferrous metals, or any combination thereof. The material selection and structural profile of the wheel body 102 may vary depending on the load capacity, environmental exposure, and desired durability. The width of the wheel body 102 may be further selected according to the expected operating terrain and may be wider than, equal to, or narrower than the width of the transport device on which the device 100 is mounted. In one embodiment, the device 100 may be comprised of a plurality of wheel bodies 102.

An exterior surface of the wheel body 102 may be comprised of an outer layer 106 formed from a high-friction, wear-resistant material to maximize ground traction and durability. The outer layer 106 may be comprised of materials such as but not limited to any combination of natural rubber, vulcanized rubber, silicone-based elastomers, polyurethane blends, or thermoplastic elastomers that may be fiber-reinforced for enhanced mechanical strength. The outer layer 106 may further include at least one surface texture 108 (as seen in FIG. 1) for optimized surface engagement. The surface texture 108 may be comprised of but not limited to any combination of multidirectional tread patterns, intersecting grooves, raised traction cleats, outward-facing radial lugs, sinusoidal ridges, etc. Said textures 108 may be arranged in repeating or non-repeating geometric patterns and may be either continuous or segmented across the surface of the layer 106. In specific embodiments, the texture 108 may be directionally optimized to promote forward traction or lateral stability.

The device 100 may further be comprised of at least one horizontal frame member 110 positioned above the wheel body 102, as seen in FIG. 1 and FIG. 2. At least one, but preferably a pair of frame arms 112 may extend downward from opposing lateral ends of the horizontal frame member 110. The frame arms 112 may be arranged in a generally parallel or diverging configuration and may be fixed or pivotally coupled to the horizontal frame member 110 to allow for angular adjustment of the wheel axis relative to the supporting frame. Each frame arm 112 may connect to a central axle 114 extending through the wheel body 102, thereby enabling free rotation of the wheel body 102 about the axle 114. In one embodiment with multiple wheel bodies 102, the frame arms 112 may attach to each wheel body 102, and/or each wheel body 102 is comprised of independent frame arms 112 that attach to at least one horizontal frame member 110.

In an additional embodiment, the horizontal frame member 110 may be further comprised of at least one extension frame member 116 that extends laterally from the frame member 110 and may be fixedly or removably attached (as seen in FIG. 2) to the member 116 via a fastener assembly 117 such as but not limited to a bolt and nut assembly 117. The extension frame member 116 may serve as a support for at least one secondary horizontal frame member 118, which may be arranged parallel to or at a skewed angle relative to the axis of the wheel body 102. This secondary frame member 118 may provide a mounting interface for a cleaning mechanism 120.

In one embodiment, a cleaning interface 120 may extend downward from the secondary frame member 118 in such a manner that the interface 120 maintains surface contact with at least one area of the outer layer 106, as seen in FIG. 1 and FIG. 2. In one embodiment, the cleaning interface 120 may be comprised of a plurality of bristles (as seen in FIG. 1) arranged in configurations such as but not limited to linear rows, radial arrays, or staggered clusters. The bristles may be made from flexible or semi-rigid materials such as but not limited to nylon, polypropylene, polyester, stainless steel wire, or carbon-fiber-reinforced polymers. Alternatively, or in combination, the cleaning interface 120 may be comprised of a scraping element (as seen in FIG. 2) such as but not limited to any combination of flexible rubber fins or rigid cleaning blades capable of mechanically dislodging particulate accumulation.

During motion of the wheel body 102, the cleaning interface 120 may actively dislodge materials such as mud, compacted soil, gravel, sand, plant matter, or other debris that accumulates on the outer layer 106. In one embodiment, the cleaning interface 120 may be mechanically linked to the secondary frame member 118 via a spring mechanism 122, as seen in FIG. 2. The spring mechanism 122 may apply a consistent downward force, ensuring that the cleaning interface 120 maintains effective contact with the surface of the wheel body 102 regardless of surface inconsistencies or progressive wear of the outer layer 106.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cylinder roller wheel device” and “device” are interchangeable and refer to the cylinder roller wheel device 100 of the present invention.

Notwithstanding the foregoing, the cylinder roller wheel device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cylinder roller wheel device 100 as shown in the FIGS. are for illustrative purposes only, and that many other sizes and shapes of the cylinder roller wheel device 100 are well within the scope of the present disclosure. Although the dimensions of the cylinder roller wheel device 100 are important design parameters for user convenience, the cylinder roller wheel device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cylinder roller wheel device comprising:
a cylindrical wheel body comprised of an outer layer comprised of a surface texture;
a horizontal frame member positioned above the wheel body;
a frame arm extending downward from a lateral end of the horizontal frame member, wherein the frame arm is coupled to a central axle extending through the wheel body; and
a cleaning interface attached to the horizontal frame member, wherein the cleaning interface is comprised of a plurality of bristles.

2. The cylinder roller wheel device of claim 1, wherein the outer layer is comprised of a rubber, a vulcanized rubber, a silicone-based elastomer, a polyurethane blend, or a thermoplastic elastomer.

3. The cylinder roller wheel device of claim 1, wherein the surface texture is arranged continuously across the outer layer.

4. The cylinder roller wheel device of claim 1, wherein the surface texture is arranged in a plurality of segments across the outer layer.

5. The cylinder roller wheel device of claim 1, wherein the surface texture is comprised of a multidirectional tread pattern, an intersecting groove, a raised traction cleat, an outward-facing radial lugs, or a sinusoidal ridge.

6. The cylinder roller wheel device of claim 1, wherein the cylindrical wheel body is comprised of an internal reinforcement structure.

7. A cylinder roller wheel device comprising:
a cylindrical wheel body comprised of an outer layer comprised of a surface texture;
a horizontal frame member positioned above the wheel body;
a frame arm extending downward from a lateral end of the horizontal frame member, wherein the frame arm is coupled to a central axle extending through the wheel body;
a secondary horizontal frame member attached to the horizontal frame member via an extension frame member; and
a cleaning interface attached to the secondary horizontal frame member.

8. The cylinder roller wheel device of claim 7, wherein the cleaning interface is comprised of a plurality of bristles.

9. The cylinder roller wheel device of claim 7, wherein the cleaning element is comprised of a flexible rubber fin.

10. The cylinder roller wheel device of claim 7, wherein the cylindrical wheel body is comprised of an internal reinforcement structure.

11. The cylinder roller wheel device of claim 10, wherein the internal reinforcement structure is comprised of a radial rib, a spoke, or a honeycomb-pattern lattice.

12. The cylinder roller wheel device of claim 7, wherein the surface texture is comprised of a multidirectional tread pattern, an intersecting groove, a raised traction cleat, an outward-facing radial lugs, or a sinusoidal ridge.

13. The cylinder roller wheel device of claim 7, wherein the secondary horizontal frame member is removably attached to the horizontal frame member.

14. A cylinder roller wheel device comprising:
a cylindrical wheel body comprised of an outer layer comprised of a surface texture;
a horizontal frame member positioned above the wheel body;
a frame arm extending downward from a lateral end of the horizontal frame member, wherein the frame arm is coupled to a central axle extending through the wheel body;
a secondary horizontal frame member attached to the horizontal frame member via an extension frame member; and
a cleaning interface attached to the secondary horizontal frame member via a spring mechanism.

15. The cylinder roller wheel device of claim 14, wherein the cleaning interface is comprised of a plurality of bristles.

16. The cylinder roller wheel device of claim 15, wherein the cleaning element is comprised of a flexible rubber fin.

17. The cylinder roller wheel device of claim 15, wherein the cylindrical wheel body is comprised of an internal reinforcement structure.

18. The cylinder roller wheel device of claim 17, wherein the internal reinforcement structure is comprised of a radial rib, a spoke, or a honeycomb-pattern lattice.

19. The cylinder roller wheel device of claim 15, wherein the surface texture is comprised of a multidirectional tread pattern, an intersecting groove, a raised traction cleat, an outward-facing radial lugs, or a sinusoidal ridge.

20. The cylinder roller wheel device of claim 15, wherein the outer layer is comprised of a rubber, a vulcanized rubber, a silicone-based elastomer, a polyurethane blend, or a thermoplastic elastomer.
